(19) United States
(12) Patent Application Publication
(10) Pub. No.: US 2021/0319337 A1
(43) Pub. Date: Oct. 14, 2021

(54) METHODS AND SYSTEM FOR TRAINING AND IMPROVING MACHINE LEARNING MODELS

(71) Applicant: Helios Sports, Inc., Portsmouth, NH (US)

(72) Inventors: William G. Near, Portsmouth, NH (US); Jason W. Evans, Somerville, MA (US)

(73) Assignee: Helios Sports, Inc., Portsmouth, NH (US)

(21) Appl. No.: 17/225,852

(22) Filed: Apr. 8, 2021

Related U.S. Application Data
(60) Provisional application No. 63/007,028, filed on Apr. 8, 2020.

(51) Int. Cl. G06N 5/04; G06N 20/00; A63B 24/00

(52) U.S. Cl. CPC G06N 5/04; G06N 20/00; A63B 2220/806; A63B 2220/05; A63B 24/0062

(57) ABSTRACT

A Sports Detection System including Sports Detection Device having an artificial intelligence (AI) recognition embedded therein and configured to run an Action Detection Model (ADM) that identifies and stores one or more individual sports actions on the Sports Detection Device for later offloading onto a secondary computing device. Methods for training and improving the ADM include tagging time-aligned portions of sensed and video data to be confirmed by profilers where the feedback can be run through a supervised learning algorithm to generate or update an ADM. The process of identifying and tagging identified portions of time-aligned data can be aided by integrating data mining and pattern recognition techniques.

### CROSS-REFERENCE TO RELATED APPLICATIONS

This application claims the benefit of U.S. Provisional Patent Application No. 63/007,028 filed on Apr. 8, 2020; which is herein incorporated by reference in entirety.

### FIELD OF THE INVENTION

The present invention relates generally to aspects of detecting sports actions using a Sports Detection Device having embedded therein an artificial intelligence sports recognition engine and methods to train the recognition engine to identify specific motions or actions of a sport or activity.

### BACKGROUND OF THE INVENTION

Sports analytics is a space that continues to see a lot of growth. In particular, various artificial intelligence and machine learning processes are being utilized to ascertain a variety of new trackable statistics including how far a player has traveled in a given game or on a given play. The amount of energy being exerted. Techniques regarding running, jumping, hitting, dribbling, shooting, skating and so forth.

Various wearable devices have been developed over the years to sense and gather data associated with various physical activities. For example, a pedometer is one of the earliest forms of a wearable device that could calculate the number of steps an individual has taken. These devices have advanced with improved sensors, accelerometers, gyroscopes, heart rate monitors, and so forth.

Although, some of the basic motion activities, such as running, walking and even swimming have been developed, there exists a need to detect and determine more types of sports actions, in a more efficient manner, with higher precision, and in way that enables feedback to be received faster. For instance, currently, a lot of the advanced statistics are being analyzed after-the-fact (meaning after a lot of sensed data is received and uploaded) using significantly larger computing resources located on a laptop or in the cloud to perform the analysis necessary to achieve these statistics.

Alternatively, where processing is primarily performed on the actual wearable device or in combination of sending and receiving data (usually wirelessly) expensive hardware and high-capacity batteries are needed to. One example, is several of the FITBIT smartwatches utilize cloud computing techniques once data is uploaded to a smartphone or into the cloud to perform the analysis, whereas APPLE's smartwatches utilized more on-board processing to perform analysis as well as numerous other functions. The result is the FITBIT smartwatches require charging less frequently than the APPLE watches. Thus, a better solution is required to reduce analysis time, as well as generate and update more effective machine learning and artificial intelligent solutions that can identify new sports actions, identify sports actions faster, and improve upon wearable sensing devices, so that they last the requisite time, ideally through an entire training session without being overly cumbersome or bulky.

The present application seeks to solve some of these identified problems as well as other problems that will become apparent to those skilled in the art.

### SUMMARY OF THE INVENTION

The present application relates to an artificial intelligence (AI) sports recognition engine capable of identifying specific motions or actions of a sport or activity.

In one embodiment the AI recognition engine is provided sensor data input and the AI recognition engine produces a pre-defined recognition (sports action) result output. The sensor data input could be single- or multi-axis motion sensing from an Inertial Measurement Unit (IMU), accelerometer or gyroscope, or another sensor including but not limited to radar, RFID, pressure and temperature. The set of possible pre-defined recognition results depends on application and motions or actions tagged during training model generation.

The AI recognition engine includes a configurable processing node located close to the semiconductor sensing elements and derives its functional intelligence from an Action Detection Model (‘ADM’). The ADM is a training model that resides inside the AI recognition engine and is generated from training data using supervised learning or machine learning or other AI methods.

Context-specific data processing provides additional intelligence to the AI recognition engine by using pre-defined rules or assumptions known for the given application. For example, when applied to the action of skating, there could be a minimum time duration that is required between two skating recognition results based on practical limitations of human locomotion. This knowledge comes from practical context of the action of skating and can be used to interpret or filter the results of the AI recognition engine to improve accuracy. A context-specific data processing model can be uploaded into the AI recognition similar to the ADM.

The AI recognition engine identifies specific motions or actions of a sport or activity by calculating parameters that are common to the ADM and its results. The calculated parameters can be any number of a set of mathematical, statistical or signal processing operations on the sensor data provided to its input. Some common operations include differentiation, integration, mean, variance, energy, peak-to-peak amplitude, maximum, minimum, thresholding techniques including zero crossing and peak detection.

In one embodiment the ADM is generated from a process of data capture through training model deployment. The process begins with capturing sensor data from a Sports Detection Device (e.g. smart puck, ball, wearable) to be used as training data for specific motions or actions of a sport or activity. The training data or subsets of the training data is/are tagged as pre-defined recognition results and parameters. The tagged results and parameters along with the training data are run through a supervised learning algorithm. The supervised learning algorithm process uses artificial intelligence methods (e.g. supervised learning, machine learning) to find the best fit for mapping the pre-defined recognition results from the captured and tagged data. The process concludes with generating a training model which creates a suitable structure to be deployed as the ADM into the AI recognition engine. Once deployed the AI recognition engine is now capable of processing sensor input and producing a pre-defined recognition result.

In one embodiment, the supervised learning algorithm uses a statistical classifier (e.g. C4.5, J48) to generate a decision tree that is repeatedly evaluated with respect to a time window to identify pre-defined recognition results occurring in that time window.

The Sports Detection Device can include an electronics board having a processing unit (CPU/MCU), memory, power, a plurality of sensors referred to as a sensor array for detecting motion along one or more axes and other sensors. The AI recognition can be located in or near the sensor array creating a sensor array system or alternatively in or near the CPU/MCU.

In one embodiment the CPU/MCU establishes a timestamp for the recognition result of the AI recognition engine, as well as raw sensed data, which can later be used to synchronize the event (or raw data) with other data sets, recognition results or a video source.

One method for training action detection models for determining a sports action for use with a sports detection system comprising the steps of 1) receiving first sensor data from a Sports Detection Device associated with an individual performing a sports action; 2) receiving first video data from a video recording device that records the individual performing the sports action; 3) aligning the first sensor data and first video data based on a time component associated with each; 4) tagging a portion of the recorded first video data that is aligned with the first sensor data with a tag indicative of the sports action; 5) analyzing remaining portions of the first sensor data aligned with the first video data to identify additional examples of the sports action based on the tagged portion; 6) generating and sending to a profiler one or more recommendations of the sports action in the form of portioned first video data based on the identified additional examples of the sports action; 7) receiving feedback from the profiler based on whether each received recommendation is indicative of the sports action; and 8) updating an action detection model training dataset based on the tagged portion and the received feedback from the profiler.

The method above can also be applied to a plurality of individuals associated with a plurality of Sports Detection Devices. The resulting tagged data and feedback from one or more profilers can be used in combination to update the ADM. Similar to the first sensed data and first video data, second, third or nth sensed data and video sets can be time-aligned accordingly.

Once an ADM model is generated or updated using the steps above it can be uploaded into the AI recognition engine, which can be integrated into the sensor array system of the Sports Detection Device.

Optionally, a context-specific data processing model can be generated and uploaded into the AI recognition engine.

Once the ADM is uploaded onto the AI recognition engine of the Sports Detection Device, the Sports Detection Device can be used to capture additional sensed data from the individual performing the sports action and further cycle that through to send new data associated with additional instances of the sports action being performed, time-aligning that with new video data, sending recommendations of portions of the time-aligned data indicative of the specific sports action to a profiler and running the profiler feedback through the supervised learning algorithm to again update the ADM.

In the embodiments above the tagging step can include creating a start and stop marker around the sports action, which can be done initially manually by a profiler and later automatically once run through a data-mining process. When the profiler receives automated recommendations showing the sports action, the profiler can in addition to confirming if the recommendation is indicative of the sports action modify the start and stop markers of the recommendation, which feedback can be used by the supervising learning algorithm.

Similar to the above method embodiments, a crowd-sourcing method for training models for determining a sports action for use with a sports detection system comprising the steps of: 1) providing a plurality of sports detection devices to a plurality of individuals about to perform a first sports action, wherein each sports detection device includes a sensor array system, a CPU or MCU, memory and a power source; 2) receiving sensed data from each of the plurality of sports detection devices of each session where the first sports action is performed by one of the plurality of individuals; 3) receiving video data from each of the sessions above; 4) aligning by a time component the sensed data to the video data; 5) tagging by a plurality of profilers, portions of the aligned sensed and video data that are indicative of the first sports action; 6) sending the tagged portions of data to a cloud-based computing device running a supervised learning algorithm; and 7) updating or generating an action detection model based on the plurality of tagged portions of data.

In the crowdsourcing method above each profile can received one or more recommendations to approve or reject.

The crowdsourcing method can further include the step of uploading to at least a subset of the plurality of sports detection devices the action detection model into an AI recognition system disposed in the sensor array system.

The crowdsourcing method can further analyze the feedback from the one or more profilers of the portioned data received from the additional sessions using the cloud-based computing device running the supervised learning algorithm to update the action detection model.

The crowdsourcing method can further include the step of uploading to at least a subset of the sports detection devices the updated action detection model.

The crowdsourcing method can further include the step of training the action detection model to identify a second sports action by repeating the steps above for the second sports action in place of the first sports action.

In yet another embodiment, a method for improving an action detection model for determining a sports action for use with a sports detection system comprising the steps of: 1) automatically identifying data of a plurality of potential first sports actions from sensed data captured on a plurality of sports detection devices wherein each has a first revision action detection model loaded into an AI recommendation engine that is part of a sensor array system of each of the sports detection devices; 2) aligning in time video data associated with the sensed data; 3) portioning the video data according to the identified data of plurality of potential first sports actions; 4) receiving feedback from one or more profilers whether or not each portioned video data is indicative of a first sports action; and 5) analyzing the profiler feedback using a secondary computing device executing a supervised learning algorithm to update the first revision action detection model as a second revision action detection model for later uploading onto each of the sports detection devices to be used again to identify another set of potential first sports actions using the second revision action detection model.

A customization method embodiment can include customizing an action detection model used for determining a sports action for use with a sports detection device for an individual comprising the steps of: 1) using the sports detection device with an individual when performing a first sports action, wherein each sports detection device includes a sensor array system, a CPU or MCU, memory and a power source; 2) receiving sensed data from the sports detection device of each session where the first sports action is performed by the individual; 3) receiving video data from each of the sessions above; 4) aligning by a time component the sensed data to the video data; 5) generating using an action detection model recommending portions of the aligned sensed and video data that are indicative of the first sports action; 6) sending the recommendations to a profiler; 7) receiving feedback from the profiler based on whether each received recommendation is indicative of the sports action; 8) comparing the feedback using a secondary computing device running a supervised learning algorithm; and 9) generating an individualized action detection model based on the comparison step.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1A illustrates a processing block diagram for an AI recognition engine that uses sensor data input and produces a pre-defined recognition result;

FIG. 1B illustrates a processing block diagram for the AI recognition engine of FIG. 1A with further details on the inside of the recognition engine;

FIG. 2 illustrates the process steps for generating a training model for use with an AI recognition engine;

FIGS. 3A-B illustrate electronics block diagrams with an AI recognition engine functional block for use with a Sports Detection Device;

FIG. 4A illustrates a smart wearable with an embedded AI sports recognition engine;

FIG. 4B illustrates an example placement and mounting location of the smart wearable of FIG. 4A on protective shoulder pads;

FIGS. 5A-C illustrate various views of a smart hockey puck with an embedded AI sports recognition engine;

FIGS. 6A-B illustrate various individuals performing sports actions while using Sports Detection Devices having an AI recognition engine embedded therein;

FIG. 7 illustrates various components of a Sports Detection System;

FIGS. 8A-B are flowcharts of a method of generating/updating an Action Detection Model (ADM) including the data capture and processing components used;

FIGS. 9A-B are illustrative of a user interface for a profiler to tag and confirm specific sports actions;

FIG. 10 is another flowchart of a method of updating an ADM;

FIGS. 11A-B illustrate yet another flowchart updating an ADM and processing components used;

FIG. 12 illustrates a flowchart optionally generating and uploading a context-specific data processing model for use with an AI recognition engine;

FIGS. 13A-B illustrate various flowcharts for methods of updating an AI recognition engine.

### DETAILED DESCRIPTION OF THE INVENTION

To provide clarity, the applicants would like to provide context around certain terms used throughout this description that is in addition to their ordinary meaning.

Artificial Intelligence (AI) recognition engine 100 is used to determine a sports action using a configurable processing node(s) that are configured to have machine learning or other AI methods or models encoded therein. In some variants, additional context-specific data processing methods or models can also be encoded therein and be a part of the AI recognition engine. This AI recognition engine can be part of a Sports Detection Device.

A Sports Detection Device can include a sensor array system, memory, a MCU or CPU, and power. The sensor array system can include one or more sensors as well as the configurable processing node(s) that form part of the AI recognition engine 100. It can be implemented into various wearable devices or other sports related equipment, such as smart hockey pucks. These devices can also include wireless communication components for receiving and transferring data.

An Action Detection Model (ADM) can be a training model that can be encoded onto the AI recognition engine.

A secondary computing device can include a computing device with higher processing power and generally increased memory capacity over that of a Sports Detection Device. Examples include tablets, laptops, desktop computers, cloud-computing and even smartphones.

Data Mining or Pattern Recognition methods can include various algorithms and techniques used to take tagged data, identify a pattern associated with the tagged data, so that additional data can be reviewed to identify other instances that are similar to the tagged data. For example, if the tagged data is indicative of a particular sports action, such as a skating stride or slapshot, the data mining and pattern recognition techniques can be used to identify other instances in recorded data where another skating stride or slapshot has potentially occurred.

A Supervised Learning Algorithm is configured to use to tagged data, other identified sports action data, parameterization inputs, false sports action data, and profiler feedback to generate a training model or Action Detection Model for use with the AI recognition engine. This supervised learning algorithm can consist of an outcome variable (or dependent variable) which is to be predicted from a given set of predictors (independent variables). Using these set of variables, it can generate a function that maps inputs to desired outputs. The training process continues until the model achieves a desired level of accuracy on the training data. Examples of Supervised Learning algorithms include Regression, Decision Tree, Random Forest, KNN, Logistic Regression, etc.

Parameterization inputs can include various parameters including minimums, maximums, statistical parameters, types of sensor data, for use with creating the ADM.

Data tagging or tagged data includes identifying a specific sports action in the sensed data. This can be done by a profiler, who is reviewing time-aligned video and sensed data.

A profiler can be an individual who can identify a particular sports action, which can include a wide number of physical feats performed by an individual, such as an athlete. Sports action types include skating, shooting, hitting, throwing, jumping, running, blocking, dribbling, and so forth.

Sensed data can include data that is gathered by a Sports Detection Device and can include acceleration across multiple axes, rotational motion across multiple axes, magnetic field sensing across multiple axes, temperature readings, pressure readings, impact readings, RFID feedback, signal feedback, and so forth.

Video data can include visually recorded data of an athlete performing a specific sports action. Both sensed data and video data can include timestamps for alignment.

A Sports Detection System can include one or more Sports Detection Devices, one or more video recording devices, one or more secondary computing devices, and one or more profilers or any combination thereof.

Various Sports Action Detection Methods will be further described below and can implement many of the items noted above as well as various steps.

As semiconductor sensing technology matures there are increasing advancements for integrating dedicated processing nodes close to semiconductor sensing elements. These processing nodes are configurable to be encoded with machine learning methods and other artificial intelligence (AI) methods. Traditional smart or embedded products that can sense or measure motions of a sport or activity suffer from memory limitations whereby an on-board application processor records data from sensors and possibly implements some algorithm(s) (e.g. digital filter), but ultimately these products are limited by on-board memory or processing limitations. The memory limitations typically result in requirements to maintain connectivity or proximity to a mobile device (e.g. smart phone, tablet) or data link (e.g. Bluetooth, Wi-Fi, LTE) in order to not exceed on-board memory. The processing limitations result in limited on-board algorithmic capabilities which in turn limits overall functional intelligence of such traditional smart or embedded products.

However, some of the embodiments herein utilize the integrated, dedicated and configurable processing nodes close to semiconductor sensing elements to solve the limitations noted above. These processing capabilities can be configured to implement training models for identifying specific sports actions. By integrating this level of functional intelligence into a smart product, a Sports Detection Device is realized, and large amounts of sensor data can be reduced to a substantially smaller number of pre-defined recognition outputs, freeing up valuable resources of the on-board application processor. The smaller number of pre-defined outputs is more suitably stored in on-board memory, and the dedicated processing node offloads the primary on-board application processor (e.g. CPU/MCU) which reduces the dependence of the product on outside devices or data links to circumvent on-board memory or processing limitations. This also can increase battery life of the Sports Detection Device. The Sports Detection Device implements Action Detection Models that can determine multiple types of sports actions.

Another one of the purposes of the present embodiments is to improve the ability to create a more accurate training model or Action Detection Model (ADM′) for use onboard in Sports Detection Devices configured to capture data associated with various motions or actions, and in particular motions or actions associated with a particular sport. Sports include a wide range of activities, including basketball, football, soccer, tennis, baseball and hockey. Many of the embodiments and examples described herein relate to the sport of ice hockey, but the applications pertain to multiple sports and thus the examples should not be limiting.

One of the benefits of having a more accurate ADM is in part the result of the limited processing, memory capacities and power consumption of action sensing devices. For example, in the sport of ice hockey a practice session could be held for 90 minutes or longer. Any sensing device would be required to record all of the data for 90 minutes, maintain connectivity or proximity to a mobile device or maintain a data link connection. If there were no ADM, no connectivity to a mobile device and no data link the onboard memory device would have to be large enough to capture continuous input of data from the sensor array, which could include a plurality of sensing components and/or sensing components that can detect, for example, motion in multiple vectors, such as rotation, direction, speed, and so forth. This would be impractical due to the size and cost of the required memory.

Alternatively, the sensing device could maintain connectivity or proximity to a mobile device or maintain a continuous data link connection, but this too can be limiting in many use cases. For example, in the sport hockey players often leave their mobile devices in the dressing room during a practice session.

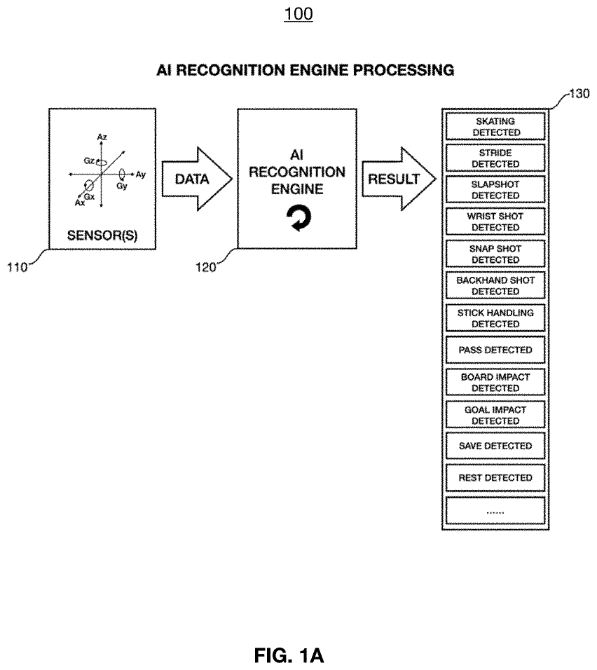

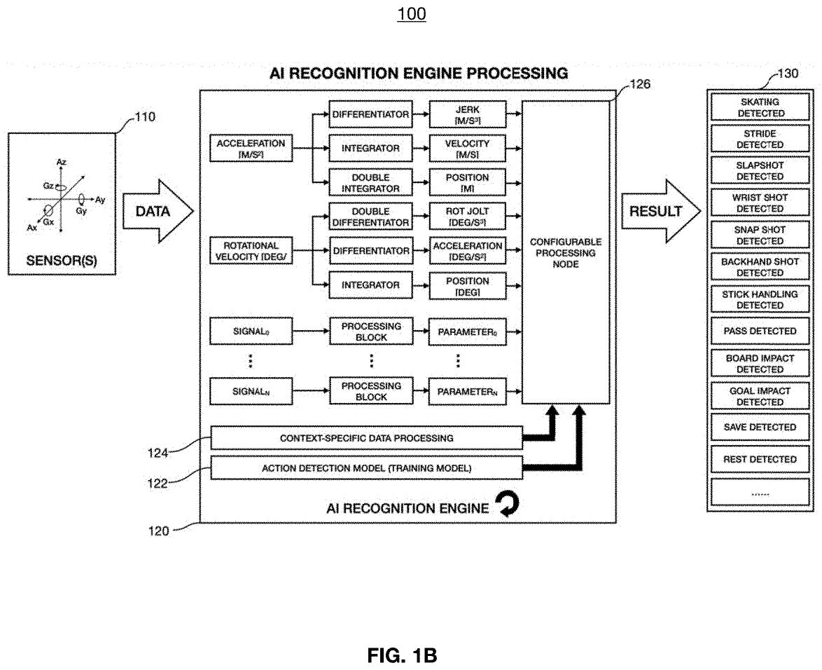

An example of sensor or sensor array 110 configured to detect multiple types of inputs is shown in FIG. 1A and FIG. 1B from sensors having 3 axis of acceleration inputs and 3 axis of rotational velocity inputs. If the main application processor were powerful enough it could do more complex analysis onboard, but then limitations in power from a battery source become a limiting factor. Thus, as described in part above, an efficient and effective ADM is needed to compensate for the limitations of onboard memory, required connectivity or proximity to a mobile device or required data link, processing and power for a sensing device.

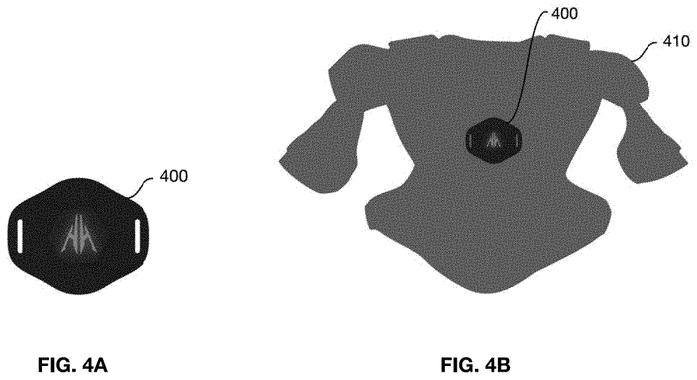

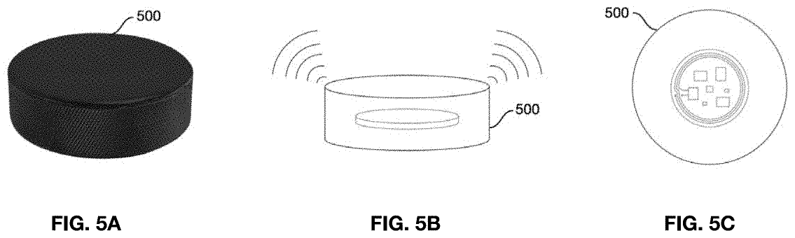

For purposes of this application Sports Detection Devices or smart devices can be integrated into sports equipment such as pucks, balls, and bats (some examples shown in FIGS. 5A-C) as well as into wearable devices (an example shown in FIG. 4A-B) that can be worn by a player or integrated into gear worn by a player including jerseys, pads, helmets, gloves, belts, skates and so forth. The Sports Detection Devices are configured to capture data associated with a motion or action associated with a player, such as the data associated with a skating motion or action of an ice hockey player.

The sensor array 110 can capture data such as acceleration, rotational velocity, radar signature, RFID reads, pressure and temperature readings. The data can be stored in the memory and later transferred to a secondary computing device. The secondary computing device may be a laptop computer, a desktop computer, a local server, a smart phone, a tablet, or a cloud server, such as shown in FIG. 7. The data can also be pre-processed, analyzed or filtered utilizing the ADM prior to storing in memory to utilize the capabilities of the ADM to reduce memory footprint.

In one embodiment, sensor data is captured by the sensor array and sent to the artificial intelligence (AI) recognition engine that includes an ADM to determine a sports action performed by the player, such as a skating action. FIG. 1A illustrates a processing block diagram for the AI recognition engine that uses sensor data input and produces a pre-defined recognition result. The pre-defined recognition results 130 can be categorized into various specific sports actions, such as shown in FIG. 1A, but not limited to: skating detection, stride detection, slapshot detection, wrist shot detection, snap shot detection, backhand shot detection, stick handling, pass detection, board impact detection, goal impact detection, save detection, rest detection, being-checked detection, and so forth.

FIG. 1B illustrates the processing block diagram of FIG. 1A with further details on the inside of the AI recognition engine 120. The sensor data received from the sensor array 110 may include acceleration, rotational velocity, magnetic field strength, radar signature, RFID reads, pressure and temperature. The sensor data is then mapped as one or more signals into one or more processing blocks that produce one or more parameter outputs in the AI recognition engine 120. For example, the acceleration sensor data could enter into processing blocks that include a differentiator, an integrator, or a double integrator. Theses processing blocks would produce parameters such as jerk, velocity, and position of the sensor respectively. The rotational velocity sensor data could enter into other processing blocks that include an integrator, a differentiator, and a double differentiator. These processing blocks would produce parameters such as position, rotational acceleration, and rotational jolt of the sensor respectively. The same or additional data can be entered into additional processing blocks to determine additional parameters. The parameters are then processed and compared to the ADM (training model) 122 by a configurable processing node 126 to determine a sports action associated with the determined parameters over the time period of interest. The configurable processing node 126 is set to match specific parameters or data with specific sports actions in the ADM. The AI recognition engine results are improved by a context-specific data processing model 124. The context-specific data processing model 124 can function as an additional layer to provide better accuracy to the ADM. For example, the context-specific data processing model 124 can provide fixed boundaries or limitations for certain sports actions, whereas the ADM might still consider those or not appreciate the order of operations. One specific example includes detecting skating strides. The ADM might detect sequential skating strides, and output right stride, left stride, left stride, left stride, right stride. The context-specific data processing model 124 would recognize that there is a sequential order to the strides and override what the ADM perceived as 3 left strides in a row to modify the middle left stride to a right stride. Thus, in combination the ADM 122 and context-specific data processing model 124 can more accurately output identified sports action results 130.

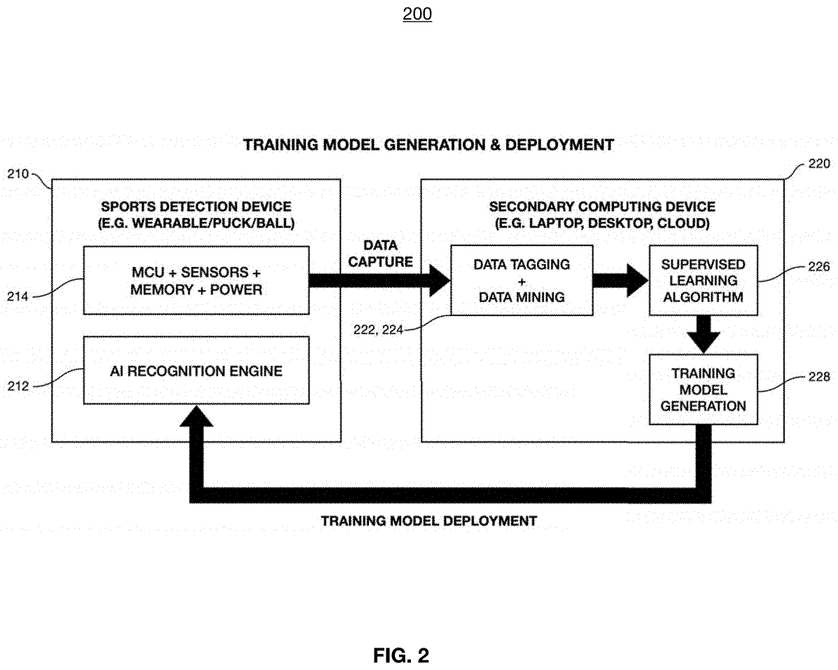

FIG. 2 illustrates an embodiment for a process 200 of generating or updating an ADM (training model) 228 that is used by the AI recognition engine 212. A Sports Detection Device 210 that is associated with an individual is placed on or in sports equipment or gear and collects data using the embedded electronics 214, which includes power, memory and sensor array, as well as the AI recognition engine 212. This collected data that can be raw sensor data or pre-filtered by the AI recognition engine is sent to a secondary computing system 220 that can include other processing devices, such as computers or cloud-based computing devices. The collected data can then tagged 222 for instances of a specific sports action identified and data-mined 224 using the tagging to identify additional instances in the collected data of the sports action. This data tagging 222 and data-mining 224 output can then be sent to a supervised learning algorithm 226 or machine learning or other AI methods that generates or updates an ADM (training model) 228. The ADM (training model) 228 is then deployed and utilized to update the AI recognition engine 212 onboard the Sports Detection Device 210 to distill the sensor data received to a specific sports action that is again stored in memory and can then be sent again to secondary computing for further refinement as noted. It should be noted that the data tagging can be performed by a profiler. The parameterization input can also be performed by a profiler, user, or data-scientist. The data tagging can be aided by data mining and pattern recognition techniques further discussed below, which help expedite the data-tagging process.

When the Sports Detection Device is in the training mode, the process described above is used to continually update and optimize the ADM (training model) and AI recognition engine to improve the performance of the AI recognition engine. Each time data that is not recognized can later be tagged and parameterized and added to the list of pre-defined sports actions or improve a training dataset. A refinement of individual actions can be developed through this process, which can in turn be utilized to identify additional actions or improve accuracy of the ADM (training model) associated with different types of individuals. For example, a base ADM (training model) may be initially applied for broad skating detection but it could improve over time to more accurately recognize the stride of a 6′2″ individual from that of a 5′8″ individual.

In the recognition mode, onboard memory usage is optimized to store data or results when the AI sports recognition determines a match between the sensor data and one of a specific set of pre-defined sports actions in the ADM (training model). Accordingly, data from the sensors that does not correspond to a pre-defined (or currently monitored) sports action is not saved in the memory. This enables the smart device to record data for a much longer period of time before the onboard memory device becomes full.

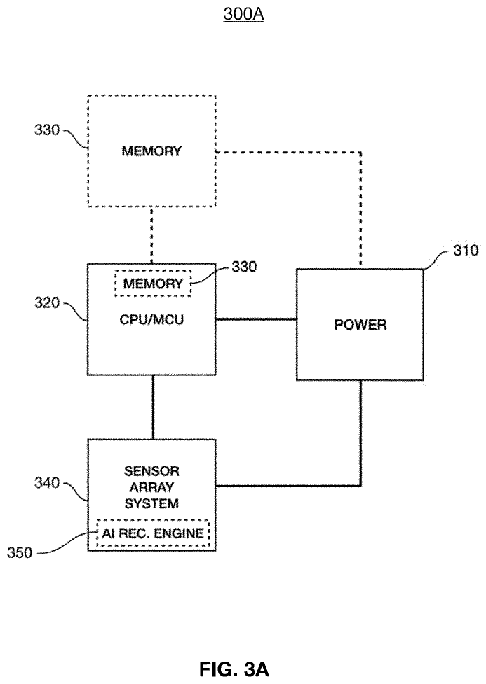

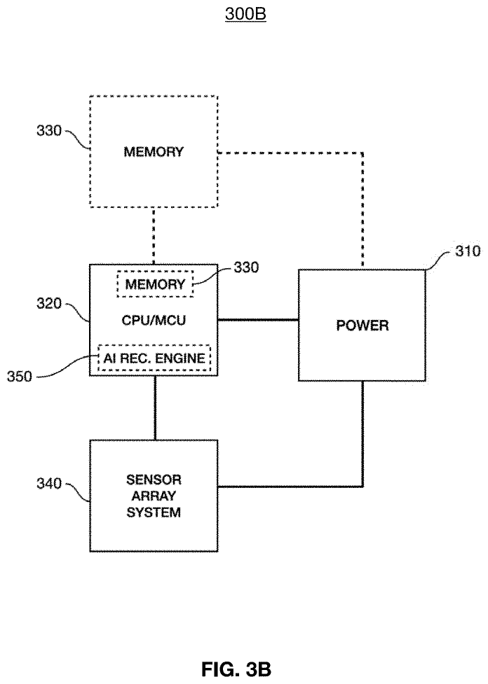

FIGS. 3A-B illustrate electronics block diagrams with an AI recognition engine functional block 350, which can be integrated into a Sports Detection Device. As shown, in one configuration a Sports Detection Device electronic block 300A includes a power supply 310, microprocessor (MCU) or CPU 320, one or more sensors that can be part of a sensor array system 340, memory 330 and AI recognition engine 350 that is comprised of processing nodes configured to run an ADM 122 and/or Context-Specific Data Processing Model 124, such as shown in FIGS. 1A-B. As shown in 300A, 350 is integrated directly into the sensor array system 340. Memory 330 can be optionally integrated with the CPU/MCU 320 or configured separately. Alternatively, as shown in Sports Detection Device electronic block 300B, the AI recognition engine 350 can be integrated with the CPU/MCU 320. However, integrating the AI recognition engine directly into the sensor array system is preferable if it offloads processing load, power consumption and demand from the CPU/MCU.

FIG. 4A illustrates a smart wearable or Sports Detection Device 400 with an embedded AI sports recognition engine. This device 400 can be placed or mounted in various locations including on protective shoulder pads 410 worn by a hockey player.

FIGS. 5A-C illustrate various views of a smart hockey puck 500, which is another form of a Sports Detection Device that can include an AI recognition engine with an ADM embedded therein that is configured to be generated and updated using the methods described herein.

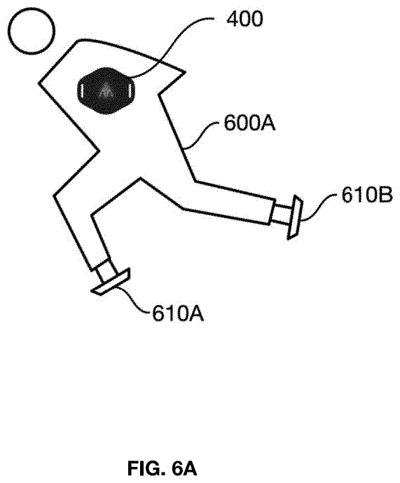

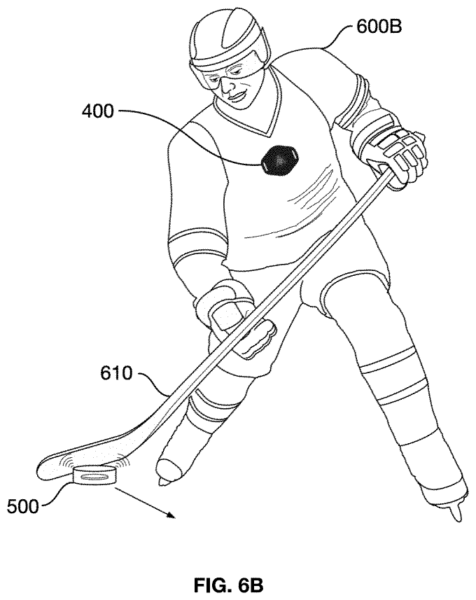

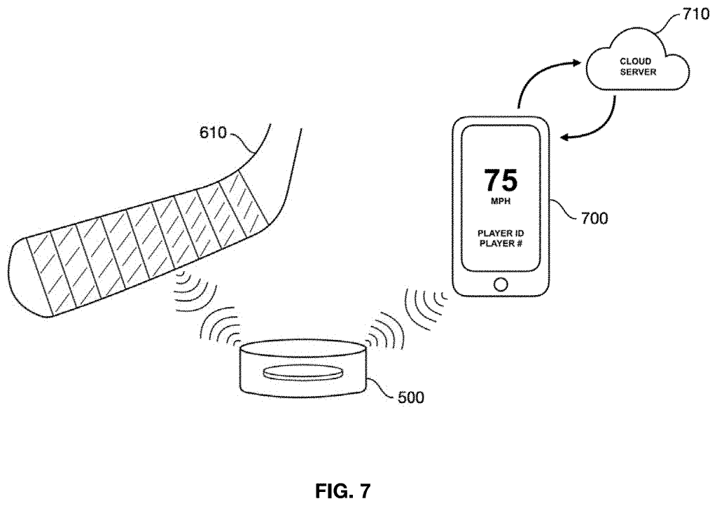

FIGS. 6A-B illustrate various individuals/athletes using Sports Detection Devices 400 and 500 having an AI recognition engine embedded therein. In FIG. 6A the individual 600A can use the device 400 to determine when a stride using skate 610A or 610B occurs. The skating data can be aligned with video and used later for analysis in coaching and training sessions, which is another purpose of acquiring accurate sports action data through the Sports Detection System and methods described herein.

FIG. 6B illustrates a hockey player 600B wearing a device 400 and also using a device 500 with hockey stick 610. When the ADM is appropriately embedded in the AI recognition of device 500 it will be able to determine when a slapshot occurred as well as all of the data associated with the given slapshot. Once aligned with video data, the system can produce each slapshot for visual inspection as well as the corresponding data associated therewith. For example, rotation, speed, contact time with the blade of the hockey stick and so forth.

FIG. 7 illustrates various components of a Sports Detection System including in this particular case a smart hockey stick 610, smart puck 500, which transmits information to a secondary computing device 700 (here shown as a smartphone), which can further process and communicate with another second computing device 710, such as cloud-computing resources.

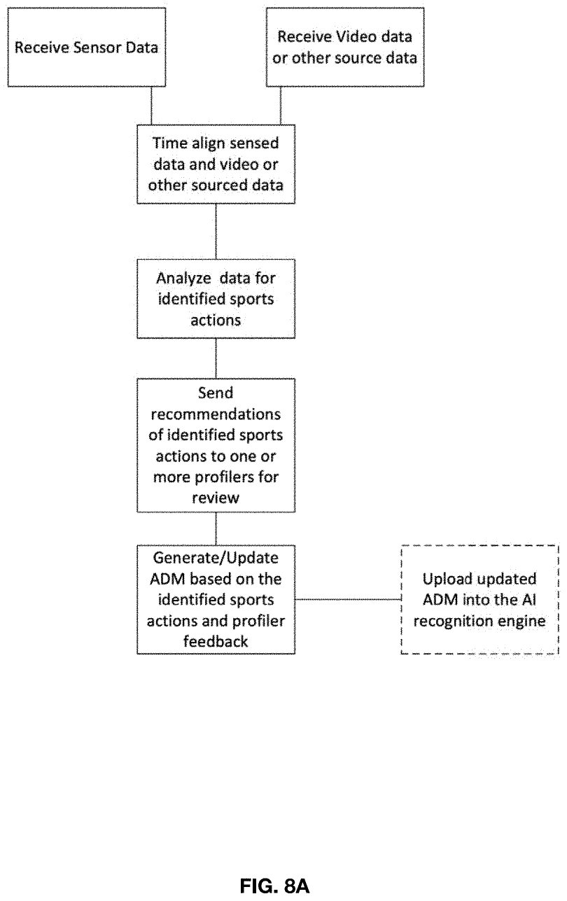

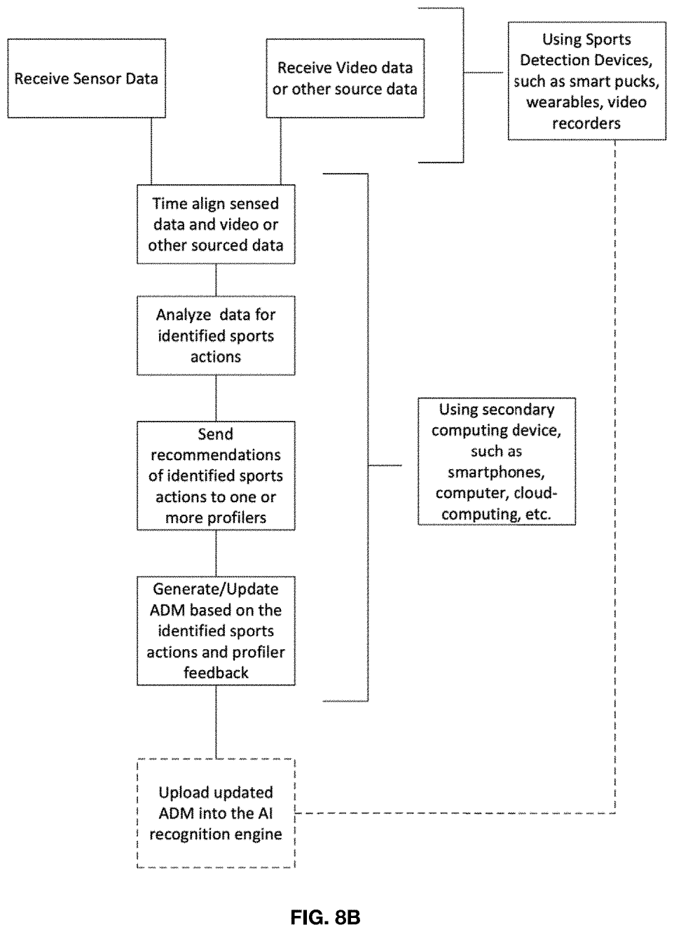

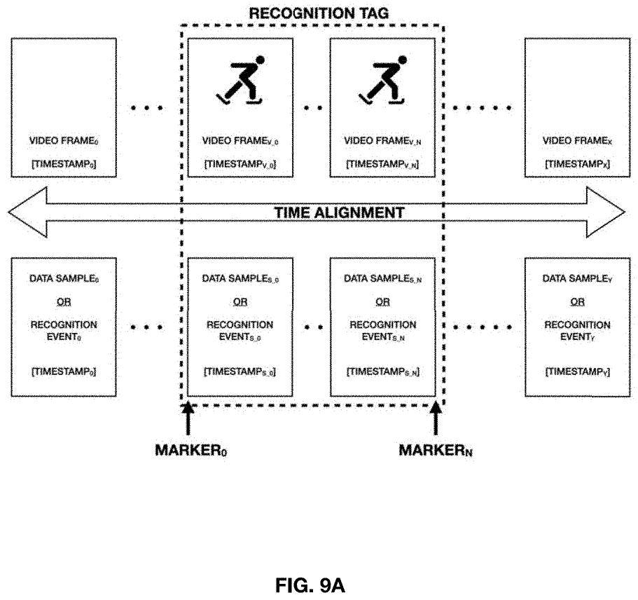

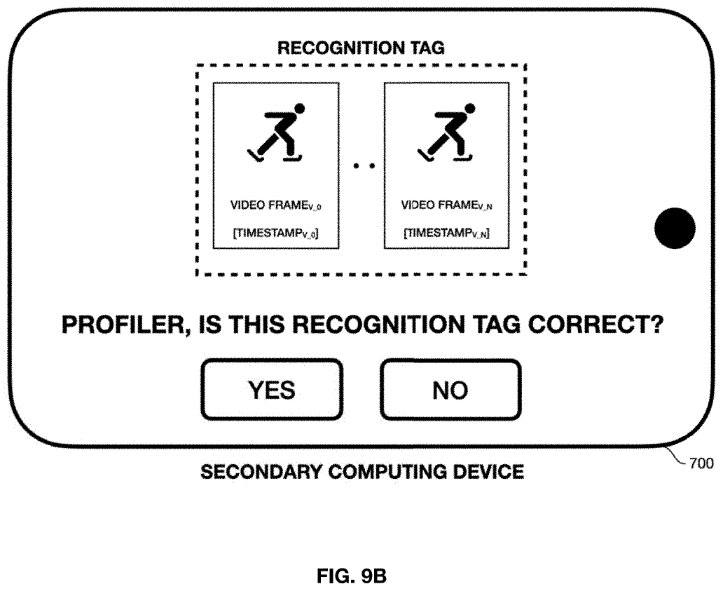

FIGS. 8A-B are flowcharts of a method of generating/updating an Action Detection Model (ADM) including the data capture and processing components used. As shown, sensed data can be received by a Sports Detection Device as noted above. Video data or other source data is also received using a video recording device, which are well-known in the art. Each of the sensed data and video data can then be time-aligned by a secondary computing device. Once time-aligned the data can be analyzed to determine an identified sports action. This analysis step can be done manually, automatically, or a hybrid of the two. For example, if the sensed data received is raw data, a profiler can review the time-aligned video to identify and tag one or more portions that are indicative of the specific sports action (see FIG. 9A). These tagged portions can then be run through various data mining or pattern recognition models or techniques configured to find additional portions within the aligned data set of potential instances of the specific sports action. Each of these additional identified potential sports action portions can then be sent to a profiler to confirm the accuracy of the recommendation and in some instances to provide additional feedback beyond the yes or no confirmation (see FIG. 9B). Some of this additional feedback can come in the form of realignment or reclassification. For example, if the section illustrating the sports action started or stopped too soon or too late the profiler could shift the data set accordingly under the realignment scenario. If the sports action recommended was similar to another sports action, for example, the sports action was a pass instead of slapshot it could be reclassified with an appropriate tag. Once the profiler feedback is received along with the aligned data a new ADM or alternatively an updated ADM can be then be created to be uploaded into the Sports Detection Device. This cycle can be repeated to refine the ADM or create an expanded set of sports actions to be detected.

FIGS. 9A-B are illustrative of a various user interfaces a profiler can use to tag and confirm specific sports actions. As shown in FIG. 9A, the video data and frames can be shown on the upper portion of the screen, which is aligned with the sensed data along the bottom portion of the screen. The profiler can use both video and sensed data to create a start and stop marker of the specific sports action. When the profiler is receiving recommendations and in some cases a plurality of recommendations an interface such as FIG. 9B can be useful to quickly confirm or reject the recommendation as one of the intended identified sports actions. These interfaces become very useful, because the profilers can be located in areas separate from where the actual sports action took place. This setup can also be used to rapidly crowd-source and train ADM using a plurality of profilers and data from a plurality of individuals performing the given sports actions. The profiler does not need to be skilled in identifying the action in the sensed data form but can instead review time-aligned video as a more user-friendly way to tag sports actions. The crowd-sourcing technique can also be continuously used to improve the ADM models, as well as provide customized models as noted briefly above for individuals or athletes of various heights, weights, skill levels, and so forth.

To further illustrate the tagging, an example of profiler identifying that at 10 min 53 sec to 10 min 54 sec a recognition tag can be placed for “skating, right stride.” Now the corresponding time-aligned sensor data can be used to create a pre-defined recognition training result for “skating, right stride.” When generating an ADM to detect a new action, the sensing device can be set to capture all of the raw sensed data. This can be uploaded and aligned with the video data on a secondary computer. The profiler can tag one or more sections of the aligned sensed and video data to be used to create an initial recommendation algorithm using data mining and pattern recognition methods as noted, which then sort through the remaining aligned data to make recommendations.

In some instances, the ADM can be refined into subcomponents of a given sports action. For example, if the initial ADM was trained to identify skating, the profiler could then begin tagging ‘left’ from ‘right’ skating. Once sufficient tagged recognition results for “skating, right stride” are established the system can review the rest of the time-aligned sensor data to try and find additional matches for the recognition results. This time-aligned sensor data can then be utilized to find the video frames matching the same timestamps and sent to the user/profiler for confirmation.

For example, the system could detect 15 possible instances or matches for the recognition results that could be automatically displayed for the user to state whether or not (yes or no) the system retrieved correct matches for the “skating, right stride” recognition result for each. As the user confirms (yes or no) on each of the additional video instances the time-aligned sensor data can be utilized to further improve the accuracy of the ADM (training model) for the “skating, right stride” sports action. Thus, profiler time can be minimized and focused on identifying initial instances of a sports action via time-aligned video or audio, and having the system retrieve additional instances without having to review an entire video. This increase the quality of the training data that will be used to generate an ADM to be uploaded into an AI recognition engine. The user can also provide additional refining data, such as individual attributes (e.g. height, weight), which the system could then utilize to retrieve individuals performing “skating, right stride” performed by individuals with varying heights, as a subset parameterization within the “skating, right stride” sports action, and conversely build an appropriate scope and range to cover “skating, right stride” for individuals of varying heights and weights. This could even be used to distinguish the type of gear used, for example hockey skate or brand of hockey skate versus a figure skate as the algorithm and refinement process utilize the methods and approaches above.

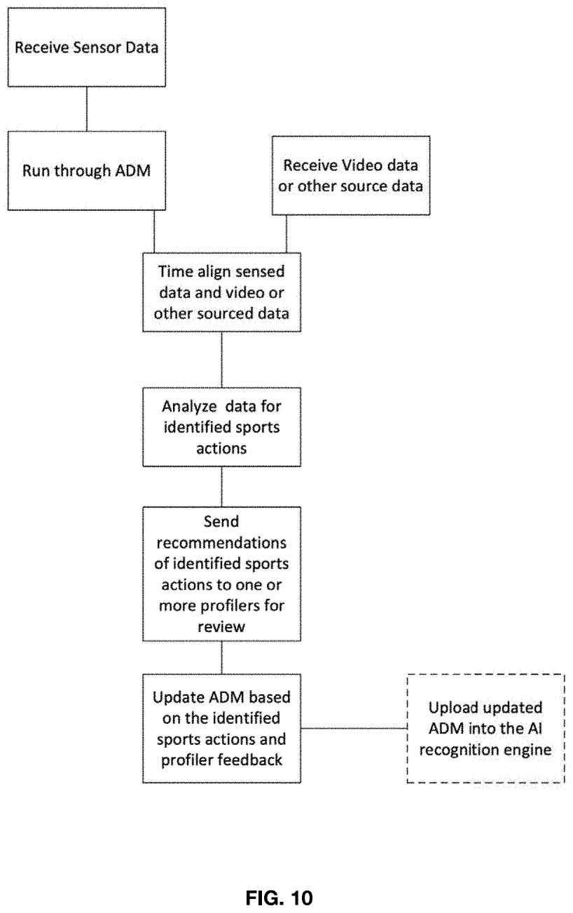

FIG. 10 is another flowchart of a method of updating an ADM. Here the sensor data is run through and filtered or distilled using an ADM before being time-aligned with video data. Once aligned the data can be analyzed to identify the specific sports actions. Here because there is at least a first-version ADM, this analysis step can be completely automated and send those identified sports actions to a profiler to confirm the accuracy, which is then fed back into supervised learning algorithm to update a second- or nth-version ADM to be uploaded back into the Sports Detection Device.

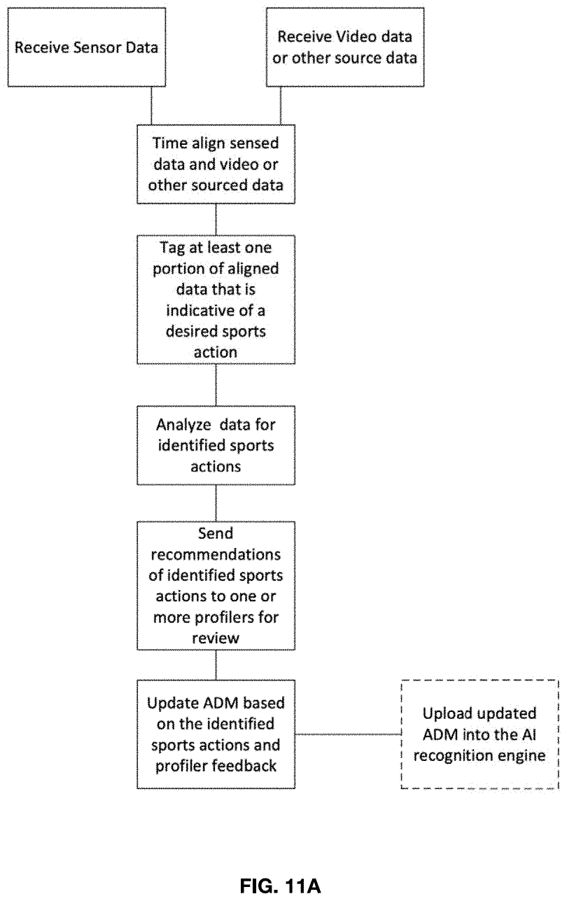

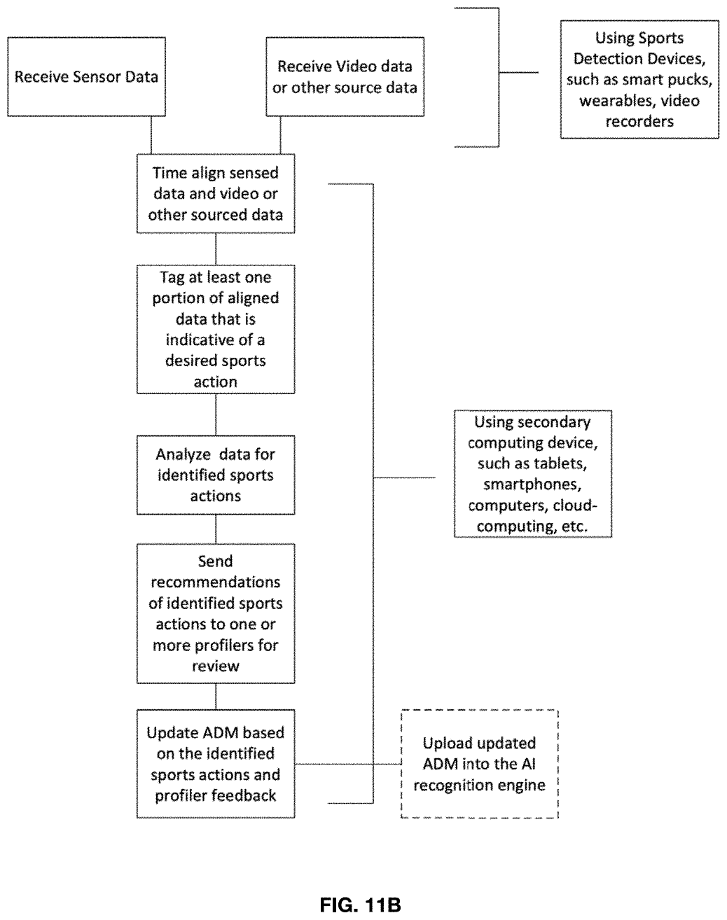

FIGS. 11A-B illustrate yet another flowchart updating an ADM, showing specifically the step of tagging a portion of the aligned data. FIG. 11B illustrates where each of these steps can be performed with using either the Sports Detection Device to receive the sensed data (and distill using an ADM if embedded) and using one or more secondary computing devices to offload the data, align it, receive feedback and update it to create an improved or modified ADM for uploading back on to the Sports Detection Device. It should be noted that the supervised learning algorithm can receive multiple sets of training data before generating an updated ADM model. It should also be noted that various ADM versions can be used across various sports detections devices associated with various individuals with the supervised learning algorithm to update an improved training model.

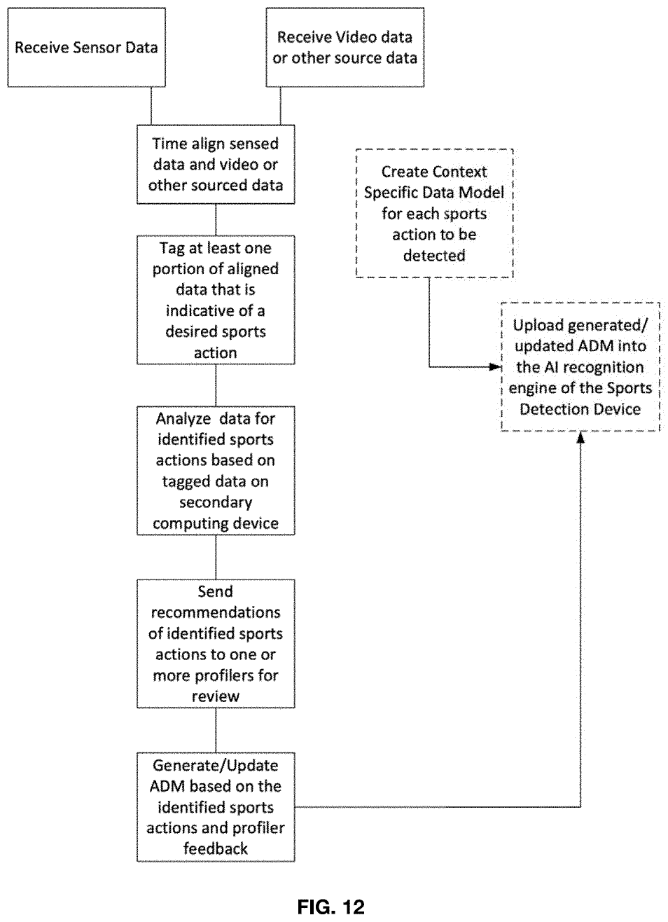

As noted above, context-specific data processing models can also be very helpful in increasing the accuracy of the detected sports actions. FIG. 12 illustrates a flowchart including the steps of optionally generating and uploading a context-specific data process model for use with an AI recognition engine.

As partially noted, multiple data sets of sensed data for multiple individuals and multiple sets of video tagging can be combined to refine the ADM (training model). The same video could be used and time aligned for multiple individuals as well. For example, 8 hockey players could be on the ice at the same time, each having a wearable sensing device and interacting with a puck having a sensing device integrated therein. Thus, 1 video could be time-aligned with 8 individual wearable devices and 1 hockey puck smart device

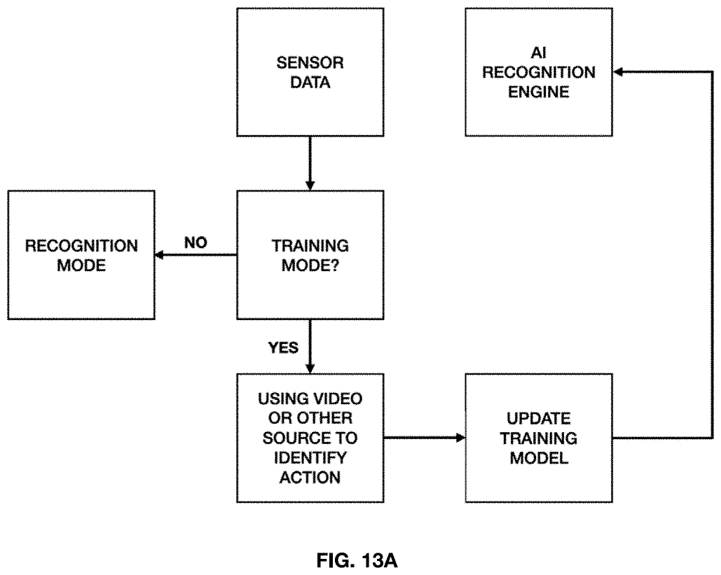

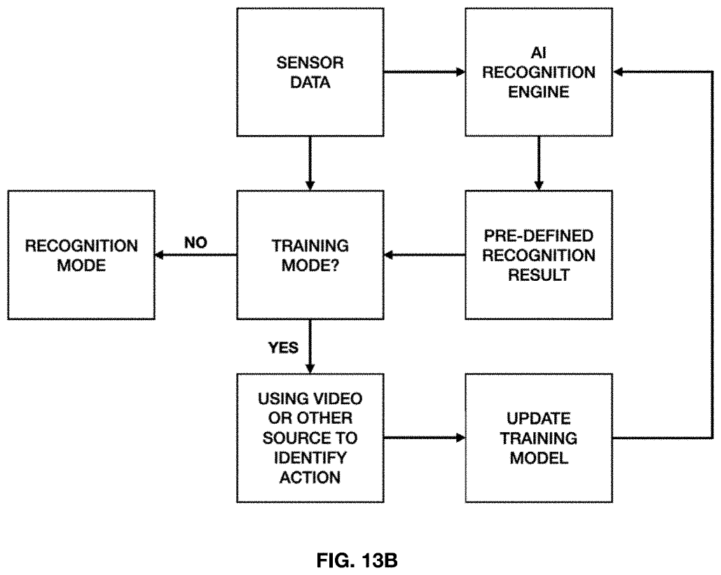

FIGS. 13A-B illustrate flow charts of a method of updating the AI recognition engine as discussed above with various action steps through the process of what to do with the data as it is received, filtered and recorded. One of the steps shown in this flow chart includes using a secondary source to identify the type of sports action that is being recorded. Some of these secondary sources can include video, audio or a blending of known actions to help with the data tagging and parameterization step noted above. If the Sports Detection Device is not in training mode than it can go into recognition mode where the ADM is not being updated and likely developed sufficiently to accurately identify the various sports actions it has been trained to identify.

Customizing an action detection model used for determining a sports action for use with a sports detection device for an individual comprising the steps of 1) using the sports detection device with an individual when performing a first sports action, wherein each sports detection device includes a sensor array system, a CPU or MCU, memory and a power source; 2) receiving sensed data from the sports detection device of each session where the first sports action is performed by the individual; 3) receiving video data from each of the sessions above; 4) aligning by a time component the sensed data to the video data; 5) generating using an action detection model recommending portions of the aligned sensed and video data that are indicative of the first sports action; 6) sending the recommendations to a profiler; 7) receiving feedback from the profiler based on whether each received recommendation is indicative of the sports action; 8) comparing the feedback using a cloud-based computing device running a supervised learning algorithm; and 9) generating an individualized action detection model based on the comparison step.

The customizing an action detection model used for determining a sports action for use with a sports detection device for an individual can further comprised the step of repeating the steps for additional individuals.

The customizing an action detection model method can also include the step of providing profile information associated with the individual performing the sports action. This profile information could be any one of height, weight, skill level, gender, age, athletic team, athletic association, or years of experience. As the profile information gets coupled with the individual performing the specific sports action the supervised learning algorithm can utilize the information to develop an ADM that can determine the difference between an athlete of varying height, weight, skill levels and so forth, because it can use both profile and tagged or identified sports action data. Thus, when updated and embedded into the AI recognition engine, the resulting output could not only be the identified sports action, but have a range of the profile information about who is performing the action, without having to ask for it. For example, the ADM could identify skating strides accomplished by an individual who likely is between 6′ and 6′2″ or weighs between 180 to 200 lbs. It might even be able to identify that the individual is (or should be) rated at a particular skill level.

The above methods and processes can lead to a sports detection device comprising a sensor array system having a plurality of sensors and an AI recognition engine; at least one CPU or MCU; memory; and a power source, wherein the AI recognition engine is configured to receive sensed data from the plurality of sensors from an associated individual performing a sports actions and identify from the sensed data using an action detection model a specific sports action and at least one range of profile information associated with the individual performing the sports actions.

It should be understood the in some instances the configurable processing nodes used in the sensor array systems can be comprised of nodes or decision tree branches from which the ADM and context-specific processing model can guide the received sensor data. These nodes can function like a decision tree and used to determine multiple types of sports actions, additional parameters such as profile information, and so forth. As a result of the relatively small number of nodes and guidance from the ADM the fast and efficient sorting or identification of data indicative of sports action does not consume heavy amounts of power or require the CPU/MCU to do a lot of onboard analysis. This also reduces the amount data, such that the memory of the sports detection device is optimized for longer detection sessions.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. A method for training action detection models for determining a sports action for use with a sports detection system comprising the steps of:
receiving first sensor data from at least one sports detection device associated with an individual performing a sports action;
receiving first video data from a video recording device that records the individual performing the sports action;
aligning the first sensor data and first video data based on a time component associated with each;
tagging a portion of the recorded first video data that is aligned with the first sensor data with a tag indicative of the sports action;
analyzing remaining portions of first sensor data aligned with the first video data to identify additional examples of the sports action based on the tagged portion;
generating and sending to a profiler one or more recommendations of the sports action in the form of portioned first video data based on the identified additional examples of the sports action;
receiving feedback from the profiler based on whether each received recommendation is indicative of the sports action; and
updating an action detection model based on the tagged portion and the received feedback from the profiler.

2. The method for training models for determining a sports action for use with a sports detection system of claim 1, further comprising the step of uploading the updated action detection model into an AI recognition engine disposed in a sensor array system of at least one sports detection device, wherein the sports detection device includes the sensor array system, a CPU or MCU, memory and a power source.

3. The method for training models for determining a sports action for use with a sports detection system of claim 2, wherein the sports detection system is comprised of a plurality of sports detection devices.

4. The method for training models for determining a sports action for use with a sports detection system of claim 3, wherein the sports detection devices can be part of smart pucks, smart balls, wearables, or another smart device.

5. The method for training models for determining a sports action for use with a sports detection system of claim 1, further comprising:
receiving second sensor data from either the first sensing data device or a second sensing device associated with a second individual performing the sports action;
receiving second video data of the second individual performing the sports action;
aligning the second sensor data and second video data based on a time component associated with each;
tagging a portion of the second recorded video that is aligned with the second sensor data with a tag indicative of the sports action performed by the second individual; and
updating the action detection model using the tagged portions of the sensor data and second video data.

6. The method for training models for determining a sports action for use with a sports detection system of claim 1, wherein the updating an action detection model step further comprises receiving from a plurality of profilers tagged portions of sensor data aligned with video data from a plurality sensing and video recording devices including a plurality of individuals performing the tagged sports action.

7. The method for training models for determining a sports action for use with a sports detection system of claim 6, further comprising the step of uploading the updated action detection model into an AI recognition engine disposed in a sensor array system of a plurality of sports detection devices, wherein each sports detection device includes the sensor array system, a CPU or MCU, memory and a power source.

8. The method for training models for determining a sports action for use with a sports detection system of claim 2, further comprising the steps of:
using the updated sports detection device during an additional sports session associated with a first or second individual to identify when the first or second individual performs the sports action;
aligning sensed data received from the updated sports detection device with recorded video of the additional sports session;
sending portions of the recorded and aligned video of the additional sports session to the profiler of at least one of the identified performances of the sports action for review; and
updating again the action detection model based on the reviewed identified performances of the sports action.

9. The method for training models for determining a sports action for use with a sports detection system of claim 1, wherein the tagging step includes creating a start and stop marker around the sports action.

10. The method for training models for determining a sports action for use with a sports detection system of claim 1, wherein the receiving feedback step further includes information related to the profiler modifying the start and stop markers of a recommendation of the sports action.

11. A crowd-sourcing method for training models for determining a sports action for use with a sports detection system comprising the steps of:
providing a plurality of sports detection devices to a plurality of individuals about to perform a first sports action, wherein each sports detection device includes a sensor array system, a CPU or MCU, memory and a power source;
receiving sensed data from each of the plurality of sports detection devices of each session where the first sports action is performed by one of the plurality of individuals;
receiving video data from each of the sessions above;
aligning by a time component the sensed data to the video data;
tagging by a plurality of profilers, portions of the aligned sensed and video data that are indicative of the first sports action;
sending the tagged portions of data to a secondary computing device to execute a supervised learning algorithm; and
updating an action detection model based on the plurality of tagged portions of data.

12. The crowd-sourcing method for training models for determining a sports action for use with a sports detection system of claim 11, wherein the profiler receives one or more recommendations of the sports action to approve or reject as correct.

13. The crowd-sourcing method for training models for determining a sports action for use with a sports detection system of claim 11, further comprising the step of uploading to at least a subset of the plurality of sports detection devices the action detection model into an AI recognition system disposed in the sensor array system.

14. The crowd-sourcing method for training models for determining a sports action for use with a sports detection system of claim 12, wherein the sports detection system using the action detection model is configured to identify when sensed data is indicative of the first sports action.

15. The crowd-sourcing method for training models for determining a sports action for use with a sports detection system of claim 13, further comprising the steps of:
aligning and portioning video data with identified sports action data received during additional sessions; and
sending the portioned data to the one or more profilers for feedback whether the portioned video is indicative of the first sports action.

16. The crowd-sourcing method for training models for determining a sports action for use with a sports detection system of claim 14, further comprising analyzing the feedback from the one or more profilers of the portioned data received from the additional sessions using the secondary computing device to execute the supervised learning algorithm to update the action detection model.

17. The crowd-sourcing method for training models for determining a sports action for use with a sports detection system of claim 15, further comprising the step of uploading to at least a subset of the sports detection devices the updated action detection model.

18. The crowd-sourcing method for training models for determining a sports action for use with a sports detection system of claim 16, further comprising the step of training the action detection model to identify a second sports action by repeating the steps of claim 16 for the second sports action in place of the first sports action.

19. Improving an action detection model for determining a sports action for use with a sports detection system comprising the steps of:
automatically identifying data of a plurality of potential first sports actions from sensed data captured on a plurality of sports detection devices wherein each has a first revision action detection model loaded into an AI recommendation engine that is part of a sensor array system of each of the sports detection devices;
aligning in time video data associated with the sensed data;
portioning the video data according to the identified data of plurality of potential first sports actions;
receiving feedback from one or more profilers whether or not each portioned video data is indicative of a first sports action; and
analyzing the profiler feedback using a secondary computing device to execute a supervised learning algorithm to update the first revision action detection model as a second revision action detection model for later uploading onto each of the sports detection devices to be used again to identify another set of potential first sports actions using the second revision action detection model.

20. The improving an action detection model for determining a sports action for use with a sports detection system of claim 19, wherein a third revision for the action detection model is generated using the steps of claim 18.

21. (canceled)

22. (canceled)

23. (canceled)

24. (canceled)

25. (canceled)

26. (canceled)

27. (canceled)

28. (canceled)

29. (canceled)

30. (canceled)
